(19) United States
(12) Patent Application Publication
(10) Pub. No.: US 2009/0289052 A1
(43) Pub. Date: Nov. 26, 2009

(54) Towel warmer rack utilizing heating by condensation

(76) Inventor: Allan Paul Bakke, Rochester, MN (US)

Correspondence Address: Allan P. Bakke, 3220 COUNTY VIEW CT SW, ROCHESTER, MN, 55902, US

(21) Appl. No.: 12/154,106

(22) Filed: May 20, 2008

(51) Int. Cl. H05B 3/06

(52) U.S. Cl. 219/521

(57) ABSTRACT

A towel rack is made of hollow, hermetically sealed metal tubing in any geometric shape such that condensed liquid returns to the lowest point of the structure by gravity. A liquid reservoir and heat source is hermetically connected to the towel rack tubing at the lowest point, comprising a vapor generator. The towel rack is evacuated, containing only the working liquid and its vapor. Heat applied to the reservoir generates vapor which travels throughout all the towel rack tubing, condensing on the inner tubing walls and heating the towel rack uniformly to the temperature of the vapor. Towel rack temperature is controlled by a solid state controller sensing the temperature of the vapor at the reservoir.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### BACKGROUND OF INVENTION

1. Field of Invention

This invention relates to towel racks, specifically to towel racks which are warmed.

2. Prior Art

Warming towels using heated towel racks has long been popular for offering a soothing and comforting sensation when a warmed towel is used after a bath or shower. Many methods have been employed, such as filling a tubular towel rack with heat transfer oil which may be electrically heated and circulated by natural convection. Another method employs electrical resistance heater wire arranged inside the tubular towel warmer. Yet another method uses hot water from external plumbing circulating through the towel warmer tubing.

While all these methods warm the tubing of the towel rack, they all have shortcomings.

The oil-filled device is typically a very low power device and is slow to warm up. Placing a damp towel on it cools the contacted bar and heat is transferred to the towel only very slowly. Natural convection of oil in the device provides a slow response to local cooling of a part of the towel rack.

Electrical resistance wire deployed inside the tubing of the towel rack provides a heating rate per inch of tubing that is constant and limited by the rate of heat transfer to the ambient air by natural convection at the maximum tube temperature allowable for safety. Thus, the towel rack temperature is difficult to predict, a factor that limits the towel rack's wattage. Because the heating rate per inch is fixed the device can not increase local heat flux in response to a localized cooling load, such as a damp towel. This limitation on heating rate also results in a long warm-up time.

Towel racks employing circulating warm water are permanently plumbed, an expensive installation, and must have some means of circulating and warming the water. In addition to the special plumbing needed to install this type of towel warmer, extra hardware such as a recirculating pump is required.

3. Objects and Advantages

Accordingly, in addition to the objects and advantages described above for heated towel racks generally, several objects and advantages of the present invention are:
(a) to provide a heated towel rack which has a very short warm-up time; about three minutes compared to thirty minutes or longer for many of the current types.
(b) to provide a heated towel rack which produces uniform temperature over its entire surface area.
(c) to provide a heated towel rack which sends heat quickly to localized parts cooled by contact with, for example, a wet towel.
(d) to provide a heated towel rack the rails and tubes of which are heated by condensation of vapor on their internal surfaces by employing the principle of a heat pipe or thermosyphon. Condensate returns by gravity to the vapor generator reservoir positioned at the lowest point of the towel rack.
(e) to provide a heated towel rack employing a solid state temperature controller to maintain a preset temperature to within plus or minus 5 degrees F.

Further objects and advantages are to provide a heated towel rack with aesthetically pleasing appearance, which can be produced at low to moderate cost. Still further objects and advantages will become apparent from consideration of the ensuing description and drawings.

### SUMMARY

In accordance with the present invention a heated towel rack comprises a hermetically sealed tubular metal towel rack in which warm vapor condenses on internal walls of the towel rack tubes, warming them as vapor changes phase to liquid and gives up its latent heat of condensation. Condensate then returns by gravity to a working liquid reservoir and vapor generator located at the most dependant and lowest point of the towel rack. The towel rack is evacuated, containing only the working liquid and its vapor. The heat pipe-thermosyphon principle produces an ideal isothermal temperature over the entire towel warmer rack surface, and sends heat to only those regions of the towel rack which have been cooled below the controlled working liquid reservoir temperature.

### BRIEF DESCRIPTION OF THE DRAWINGS

FIG. 1 is a perspective drawing of the preferred embodiment of my invention, a towel warmer rack utilizing heating by condensation.

FIG. 2 is an enlarged perspective drawing of the vapor generator of the towel warmer rack of FIG. 1.

FIG. 3 is a partially sectioned view of the preferred embodiment of the vapor generator of my invention with its cover removed.

FIG. 3A is a perspective drawing of an alternative embodiment of the vapor generator of FIG. 3.

FIG. 4 is a frontal drawing of an alternative embodiment of my invention showing an alternative embodiment of the vapor generator of my invention.

FIG. 4A is a drawing of the vapor generator of FIG. 4 with its cover removed.

FIG. 5 is a view of the vapor generator indicated by lines 5-5 of FIG. 4A and in direction of the arrows.

FIG. 6 is a sectional view of the vapor generator indicated by section

FIG. 6-6 of FIG. 5 and in the direction of the arrows.

FIG. 7 is a frontal drawing of an alternative embodiment of my invention.

FIG. 8 is an electric circuit diagram of the preferred embodiment of my invention.

FIG. 9 is an electric circuit diagram of an alternative embodiment of my invention.

### REFERENCE NUMERALS

1 preferred embodiment of towel warmer rack utilizing heating by condensation invention
2 alternative embodiment of towel warmer rack utilizing heating by condensation invention
10 hollow metal tube
12 support feet
14 grounded power cord
16 preferred embodiment of vapor generator
17 alternative embodiment 1 of vapor generator
18 solid state temperature controller
20 alternative embodiment 2 of vapor generator
22 working liquid reservoir
23 tubular working liquid reservoir
24 flexible etched foil heater
26 working liquid
28 working vapor
30 evacuation and charging tube
32 temperature sensor
34 over temperature thermal cut-off
36 thermal snap action switch
38 lighted power switch
40 over temperature failure light
42 heating light
44 tubular heater

### PREFERRED EMBODIMENT

### Description

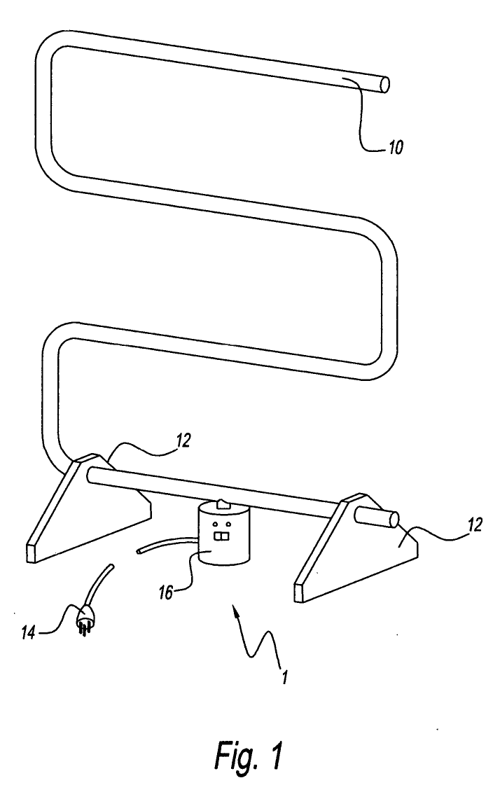

FIG. 1 shows the present towel warmer rack utilizing heating by condensation invention 1 with its main structure being hollow metal tube 10 about 0.5 to 2 inches in diameter with wall thickness about 0.03 to 0.10 inches which is fabricated so that any liquid in the tube drains by gravity to the lowest and most dependent region of the tube where preferred embodiment of vapor generator 16 is attached. Hollow metal tube 10 and preferred embodiment of vapor generator 16 are fabricated, assembled and tested to be hermetically sealed, and are leak tested using a high vacuum helium leak detector. Support feet 12 keep the device stable and level as it rests on a floor. Other means for keeping the device in a stable position and with a constant orientation to gravity, such as wall mounting hardware, may be used. The fabricated towel warmer rack utilizing heating by condensation invention 1 has about four horizontal segments each about 2 feet long connected in a serpentine shape by about three vertical segments each about 1 foot long of hollow metal tube 10. With the support feet 12 the complete towel warmer rack utilizing heating by condensation invention 1 is about 2 feet wide and about 3.5 feet high. Grounded power cord 14 provides power when plugged into an a.c. wall receptacle.

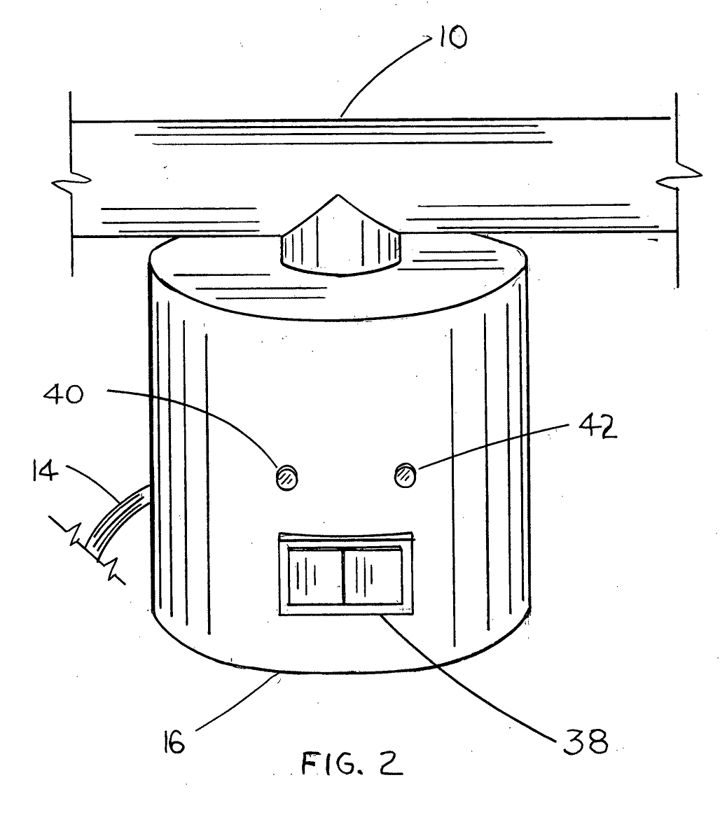

FIG. 2 is an enlarged view of preferred embodiment of vapor generator 16 showing lighted power switch 38, over temperature failure light 40 and heating light 42.

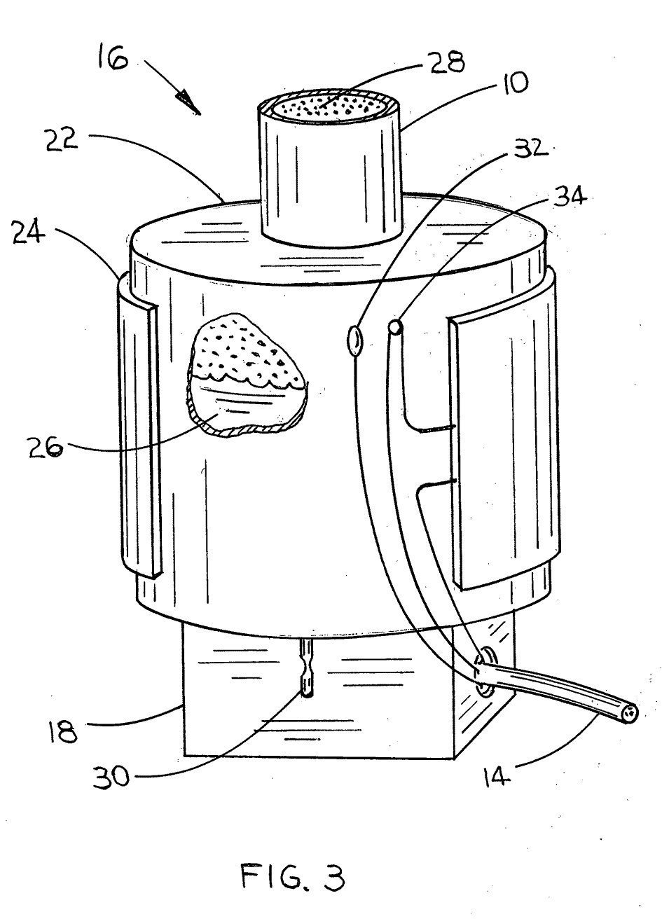

FIG. 3 is a perspective drawing of the preferred embodiment of vapor generator 16 with its outer covering removed to reveal the working liquid reservoir 22 which is about 2 to 4 inches in diameter with height about 2 to 4 inches with an internal volume of about 1 to 5 percent of the total volume of hollow metal tube 10, etched foil heater 24 about 200 to 700 watts, over temperature thermal cut-off 34 which can operate one time only at about 171 F, and temperature sensor 32. Also shown in this figure are the solid state temperature controller 18, the grounded power cord 14 and the evacuation and charging tube 30. Evacuation and charging tube 30 has outside diameter of about 0.19 inches and inside diameter of about 0.09 inches, and is used in helium leak testing and charging the working liquid reservoir 22 with a measured volume of working liquid prior to hermetic sealing by mechanical clamping and then welding or brazing the inlet. After charging and sealing, working liquid reservoir 22 and hollow metal tube 10 contain only pure working liquid and its vapor. Working liquid and the container (working liquid reservoir 22 and hollow metal tube 10) must be compatible for heat pipe use, such as copper and water. Sectioned portions of this figure show the liquid and vapor regions inside the working liquid reservoir 22 and hollow metal tube 10.

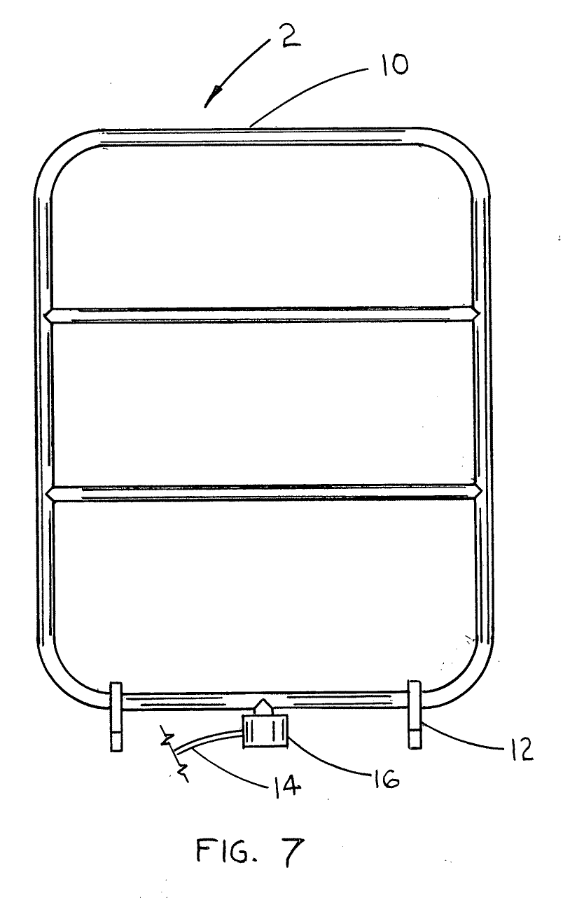

FIG. 8 is an electrical circuit diagram of the towel warmer rack utilizing heating by condensation invention 1 showing the electrical interconnections of the individual elements previously described.

### PREFERRED EMBODIMENT

### Operation

In operation the towel warmer rack utilizing heating by condensation invention 1 is powered by power cord 14 being plugged into a ground fault interrupter a.c. receptacle. Power is turned on using lighted power switch 38, which applies heat via flexible etched foil heater 24 by conduction through the wall of working liquid reservoir 22 to working liquid 26, producing working vapor 28 which then travels rapidly throughout the internal volume of hollow metal tubes 10. Heating light 42 is illuminated when power is being applied to flexible etched foil heater 24. Working vapor 28 condenses on the internal walls of hollow metal tubes 10 wherever the walls are cooler than the vapor. The condensing vapor gives up its latent heat of condensation upon changing phase from vapor to liquid, heating the internal walls of hollow metal tubes 10. The condensed liquid then flows by gravity back down to working liquid reservoir 22 where it can be further heated and re-vaporized as needed to maintain the predetermined desired towel warmer rack temperature. The predetermined desired warm temperature is maintained by solid state temperature controller 18 which uses temperature sensor 32 which may be a thermistor, thermocouple or a resistive temperature device (RTD) to sense the temperature of working liquid 26 and to control it at about 125 to 130 F. With water as the working liquid lower or higher temperatures, up to 200 F are possible while keeping interior pressures below 1 atmosphere. Solid state temperature controller 18 is the preferred means of temperature control because it has a much longer life than mechanical snap action switches, because it can maintain the controlled temperature more accurately within about 5 degrees F., and because it switches at zero voltage, causing no electronic interference. In the event of a failure resulting in the controlled temperature becoming too high, over temperature thermal cut-off 34 will break the heating circuit, preventing further heating, and over temperature failure light will illuminate (this should not occur, and would require repair). Any cooling of hollow metal tubes 10, such as by hanging a damp towel on them, causes working vapor 28 to condense, reducing the internal pressure and cooling working liquid 26 by further evaporation. Solid state temperature controller 18 then operates to apply heat and to produce more working vapor 28 which immediately travels throughout hollow metal tubes 10, condensing on and heating any internal surfaces cooler than the vapor, which is approximately the temperature of the working liquid 26 from which it was vaporized.

### ALTERNATIVE EMBODIMENT 1 OF VAPOR GENERATOR

### Description

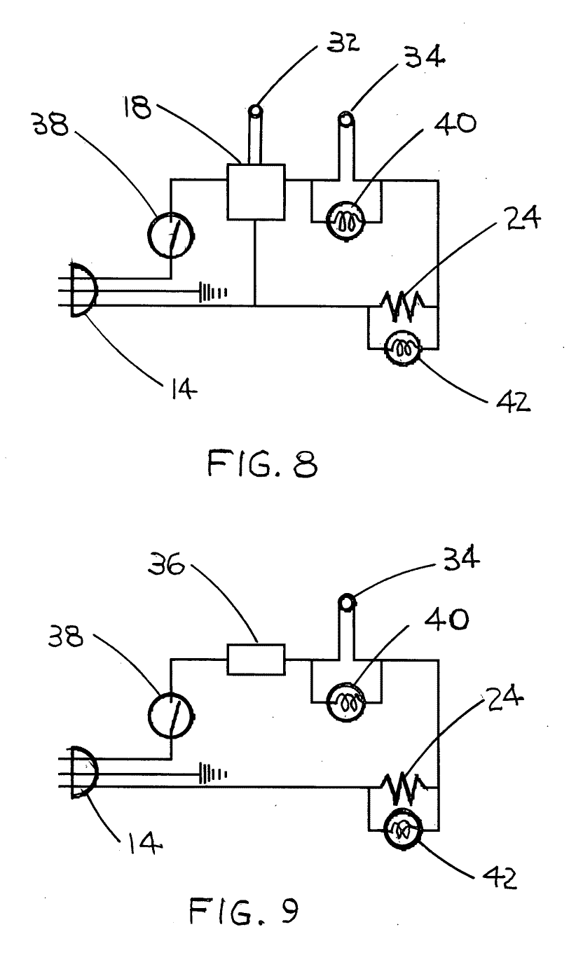

FIG. 3A and FIG. 9 shows an alternative embodiment of the vapor generator of FIG. 3. This alternative embodiment 1 of vapor generator 17 uses a thermal snap action switch 36 to control the temperature. In this embodiment, the solid state temperature controller 18 is therefore not present. FIG. 9 is an electric circuit diagram showing how thermal snap action switch 36 is interconnected with other elements to provide temperature control.

### ALTERNATIVE EMBODIMENT 1 OF VAPOR GENERATOR

### Operation

In operation thermal snap action switch 36 is initially closed when the towel warmer rack utilizing heating by condensation invention 1 (at room temperature) is plugged into an a.c. receptacle with grounded power cord 14 and lighted power switch 38 is turned on. Power is thus applied to flexible etched foil heater 24 and the towel warmer rack utilizing heating by condensation invention temperature increases as in the preferred embodiment. When alternative embodiment 1 of vapor generator 17 reaches the fixed control setting of thermal snap action switch 36 (about 120 to 130 degrees F.), the heating circuit is de-energized by the opening of thermal snap action switch 36. Towel warmer rack utilizing heating by condensation invention 1 cools by exposure to ambient room temperature air or perhaps damp towels hung on it, until it reaches the closing temperature of thermal snap action switch 36 (about 100 to 110 degrees F.), beginning a heating cycle. Thus the temperature cycles by about 20 degrees F. between lowest and highest settings.

Snap action switches have a life of about 100,000 cycles, which would give an operational duration of about one year if operated continuously. This alternative embodiment 1 of vapor generator 17 would be less costly to produce than the preferred embodiment of vapor generator 16.

### ALTERNATIVE EMBODIMENT 2 OF VAPOR GENERATOR

### Description

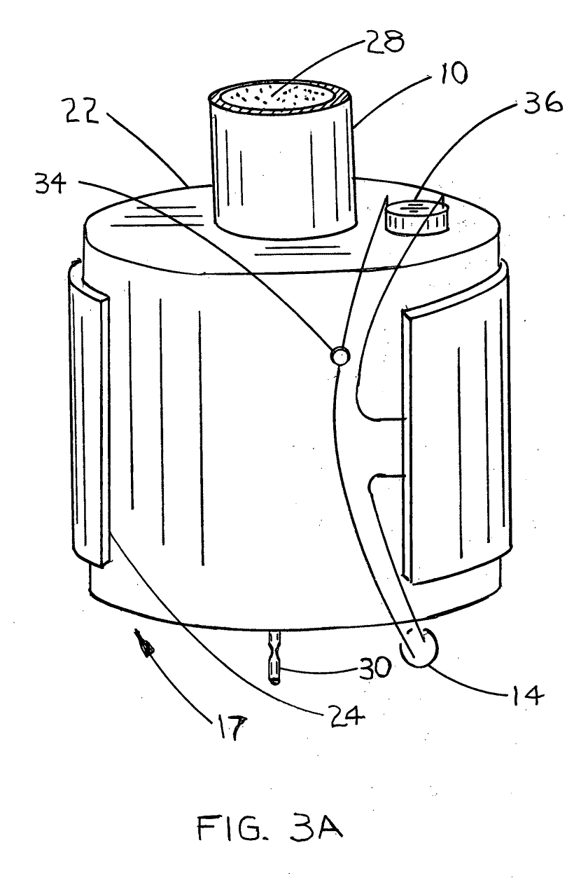

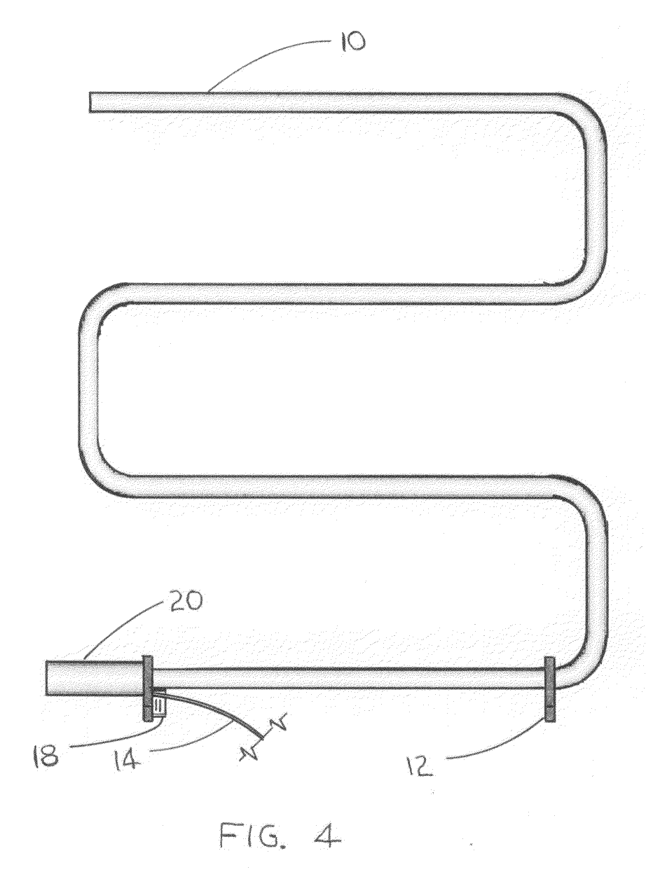

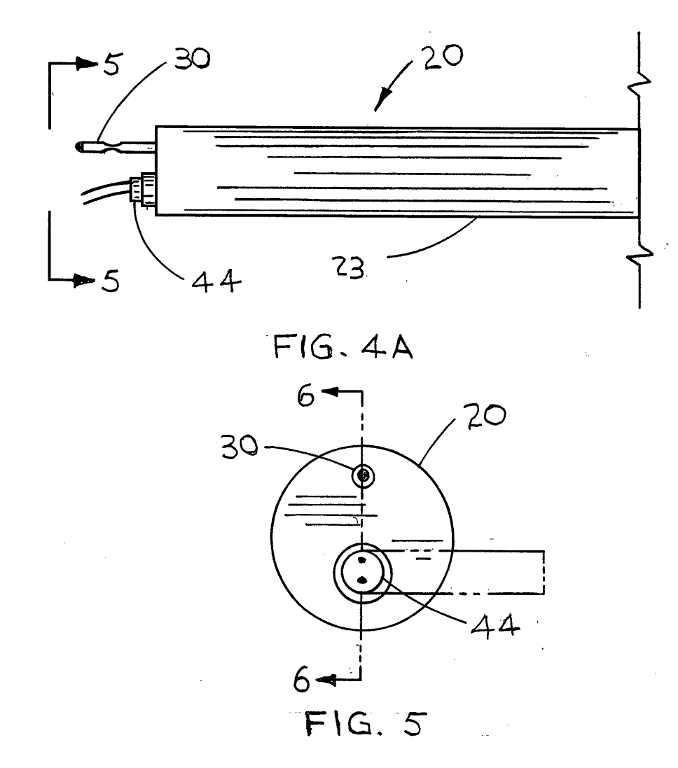

FIGS. 4, 4A, 5 and 6 depict another alternative embodiment 2 of vapor generator 20 replacing the preferred embodiment of vapor generator 16. FIG. 4 shows a frontal view of alternative embodiment 2 of vapor generator 20 which is seen projecting from the lowest terminal end of hollow metal tube 10. Solid state temperature controller 18 is shown attached to one of support feet 12. FIG. 4A shows alternative embodiment 2 of vapor generator 20 with its outer cover removed. Only tubular heater 44 is shown. Other circuit elements are not shown for clarity, because they are the same as in preferred embodiment of vapor generator 16. FIG. 5 shows an end view of alternative embodiment 2 of vapor generator 20, and FIG. 6 shows a sectional view of this alternative embodiment 2 of vapor generator 20. Working liquid 26 fills tubular working liquid reservoir 23 to about one-half its internal height. Working vapor 28 occupies the upper half of tubular working liquid reservoir 23. Tubular heater 44 slides into a close-fitting tubular recess tube, and is thus functionally outside the hermetically sealed regions of towel warmer rack utilizing heating by condensation invention 1.

### ALTERNATIVE EMBODIMENT 2 OF VAPOR GENERATOR

### Operation

In operation, alternative embodiment 2 of vapor generator 20 works essentially the same as preferred embodiment of vapor generator 16 except that heat to warm the working liquid 26 and to produce working vapor 28 is provided by tubular heater 44 which is about 0.25 to 0.5 inches in diameter and about 6 to 10 inches long, producing about 300 to 700 watts. Heat is transferred to the working liquid 26 through the walls of the tubular recess tube as shown in FIG. 6.

### ALTERNATIVE EMBODIMENT OF TOWEL WARMER RACK UTILIZING HEATING BY CONDENSATION INVENTION

### Description

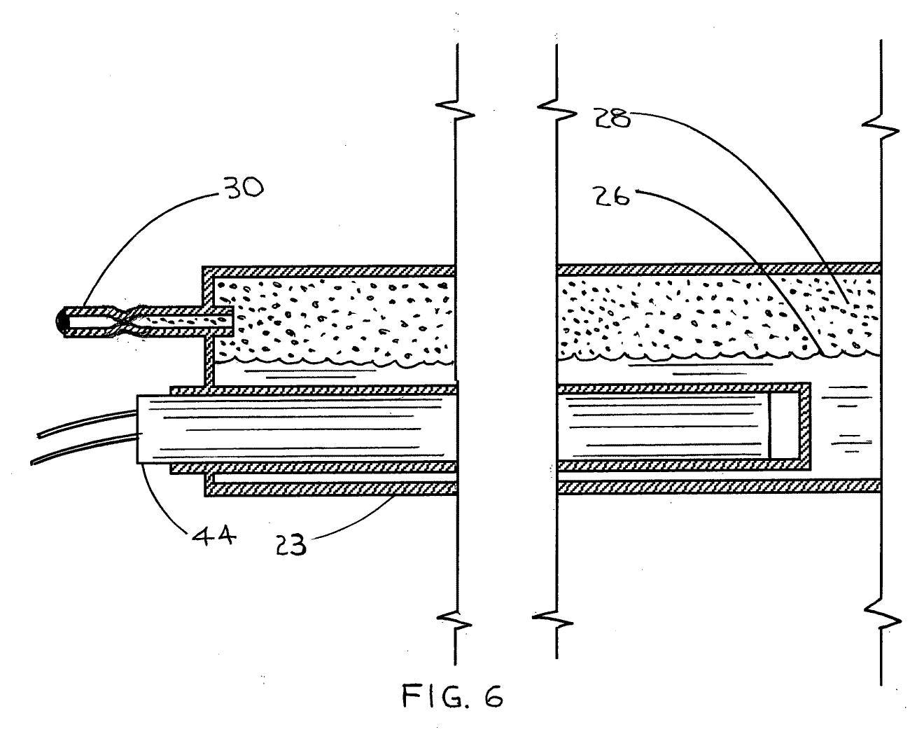

FIG. 7 shows a frontal view of alternative embodiment 2 of my invention. The only difference between this and the preferred embodiment of towel warmer rack utilizing heating by condensation invention 1 is in the geometry of the hollow metal tube 10. In the preferred embodiment, the hollow metal tube 10 is a single, continuous tube with a back and forth serpentine shape. In this alternative embodiment 2 the outer tube forms a complete loop, with intermediate horizontal tubes which intersect the outer loop of tubing. This arrangement requires two additional leak-free tubing joints for each extra horizontal tube segment, making fabrication more difficult.

### ALTERNATIVE EMBODIMENT OF TOWEL WARMER RACK UTILIZING HEATING BY CONDENSATION INVENTION

### Operation

In operation alternative embodiment of towel warmer rack utilizing heating by condensation invention 2 operates essentially the same as preferred embodiment of towel warmer rack utilizing heating by condensation invention 1. The principal difference is that there are multiple paths for working vapor 26 to traverse to reach points in the towel warmer, and likewise multiple paths for the condensed working liquid to follow to return by gravity to working liquid reservoir 22.

### CONCLUSIONS, RAMIFICATIONS and SCOPE

From the forgoing description it will be apparent that the invention disclosed herein provides a novel and advantageous heated towel warmer rack design. As will be understood by those familiar with the art, the invention may be embodied in many specific forms and geometric shapes without departing from the spirit or essential characteristics thereof. An example would be a single horizontal towel bar which may be 20 feet long or longer. Another example would be a towel rack in the shape of a circular spiral, perhaps two or three feet in diameter and two feet or more tall.

Thus the scope of the invention should be determined by the appended claims, and their legal equivalents, and not limited by the examples given.

1-9. (canceled)

10. A towel warmer rack utilizing heating by condensation apparatus comprising:
A.) a plurality of hollow metal tubes in which the hollow metal tubes comprising said plurality of hollow metal tubes are hermetically connected rigidly together such that all their lumens form a continuous flow path,
1.) all free or dead ends of said hollow metal tubes being hermetically capped or sealed,
2.) all said hollow metal tubes of said plurality of hollow metal tubes being arranged such that any liquid inside said lumens of said hollow metal tubes flows by gravity to the lowest and most dependent region of said plurality of hollow metal tubes,
3.) means for supporting said plurality of hollow metal tubes in a stable position such that its orientation to gravity is constant,
B.) a vapor generator comprising:
1.) a rigid metal working liquid reservoir,
2.) said rigid metal working liquid reservoir being adapted with a hollow metal tube means for hermetic and mechanical joining of the highest region of said rigid metal working liquid reservoir to said plurality of hollow metal tubes at said lowest and most dependent region of said plurality of hollow metal tubes, such that an open flow path connecting said rigid metal working liquid reservoir with said continuous flow path of said plurality of hollow metal tubes is produced,
3.) said rigid metal working liquid reservoir being adapted with means for evacuating, helium leak checking, and charging with a predetermined volume of working liquid compatible for heat pipe use with said plurality of hollow metal tubes and said rigid metal working liquid reservoir,
4.) sealing means to hermetically seal said means for evacuating, helium leak checking, and charging with a predetermined volume of working liquid, ensuring that said continuous flow path of said plurality of hollow metal tubes and said rigid metal working liquid reservoir contain only said working liquid and its working vapor inside said hollow metal tubes of said plurality of hollow metal tubes,
5.) electric heating means for heating said working liquid to increase its temperature and thereby increase the temperature of said working vapor filling said plurality of hollow metal tubes, warming said plurality of hollow metal tubes by condensation of said working vapor,
6.) controlling means for maintaining temperature of said working liquid and said working vapor at a predetermined desired warm temperature, using means for sensing temperature of said working liquid,
whereby said plurality of hollow metal tubes of said towel warmer rack utilizing heating by condensation apparatus quickly warms to and is accurately maintained at said predetermined desired warm temperature, ensuring towels or garments hung thereon are comfortably warmed.

11. A towel warmer rack utilizing heating by condensation apparatus according to claim 1 wherein said hollow metal tubes of said plurality of hollow metal tubes have circular cross sections and diameters of about 0.5 to 1.5 inches and said rigid metal working liquid reservoir has a right circular cylindrical shape about 2 to 4 inches in diameter and about 2 to 4 inches high and is hermetically closed at top and bottom by circular plates with diameter the same as said diameter of said right circular cylindrical shape, all the walls of said rigid metal working liquid reservoir and said plurality of hollow metal tubes being about 0.03 to 0.10 inches thick,
A.) said hollow metal tube means for hermetic and mechanical joining of the highest region of said rigid metal working liquid reservoir to said plurality of hollow metal tubes is a circular metal tube about 0.5 to 1 inches in diameter and about 1 to 2 inches long,

12. A towel warmer rack utilizing heating by condensation apparatus according to claim 1 wherein said hollow metal tubes of said plurality of hollow metal tubes have circular cross sections and diameters of about 0.5 to 1.5 inches and said rigid metal working liquid reservoir is a horizontally disposed circular cylindrical tube about 1 to 2 inches in diameter and about 6 to 12 inches long which is open at one end and hermetically closed at the other end by a flat circular plate of the diameter of said circular cylindrical tube, all the walls of said rigid metal working liquid reservoir and said plurality of hollow metal tubes being about 0.03 to 0.10 inches thick,
A.) said flat circular plate of said closed end of said circular cylindrical tube having a hollow circular cylindrical recess tube about 0.25 to 0.5 inches inside diameter, depth of about 6 to 12 inches, the centerline of said hollow circular cylindrical recess tube being parallel to and below the centerline of said circular cylindrical tube so that said hollow circular cylindrical recess tube is located entirely in the bottom one half of said circular cylindrical tube, said hollow circular cylindrical recess tube being hermetically closed at the end of its depth,
B.) said open end of said rigid metal working liquid reservoir horizontally disposed circular cylindrical tube being adapted with a hollow metal tube means for hermetic and mechanical joining to said plurality of hollow metal tubes at said lowest and most dependent region of said plurality of hollow metal tubes, such that an open flow path connecting said rigid metal working liquid reservoir with said continuous flow path of said plurality of hollow metal tubes is produced,
C.) said electric heating means being a tubular heater about 0.24 to 0.49 inches in diameter and about 6 to 12 inches long with a heating power of about 300 to 700 watts, disposed to fit closely inside and be of about equal length of said hollow circular cylindrical recess tube in said flat circular plate of said closed end of said circular cylindrical tube,
D.) said volume of said working liquid filling about half the internal height of said rigid metal working liquid reservoir horizontally disposed circular cylindrical tube.
